(19) United States
(12) Patent Application Publication
(10) Pub. No.: US 2017/0001455 A1
(43) Pub. Date: Jan. 5, 2017

(54) Print Control Apparatus and Printer

(71) Applicant: Seiko Epson Corporation, Tokyo (JP)

(72) Inventors: Shunsuke Murakami, Shiojiri-Shi (JP); Hiroyuki Tsuji, Matsumoto-shi (JP)

(21) Appl. No.: 15/196,445

(22) Filed: Jun. 29, 2016

(30) Foreign Application Priority Data
Jul. 2, 2015 (JP) 2015-133341

(51) Int. Cl. B41J 13/26; B41J 2/01

(52) U.S. Cl. CPC B41J 13/26; B41J 2/01

(57) ABSTRACT

A control unit included in a print control apparatus determines whether or not a print range of a printing job falls within a printable range of a medium calculated based on a result of detection by a detection unit in a transport direction and in a width direction crossing the transport direction, and in a case where the print range falls within the printable range, the control unit permits the execution of printing based on the printing job.

### BACKGROUND

1. Technical Field

The present invention relates to a print control apparatus that controls a printer such as an ink jet printer, and a printer including the print control apparatus.

2. Related Art

In the related art, a printer is known, which prints an image by discharging ink as an example of a liquid on a medium such as a transported sheet. Among those kinds of printers, there is a printer that stops printing in a case where a skew amount (position shift amount) of the transported medium is greater than a threshold value (first threshold value), and continues printing on the medium in a case where the above-described skew amount is equal to or smaller than the threshold value (for example, refer to JP-A-2003-330334).

Incidentally, in the printer described above, depending on the size of the medium and the size of an image to be printed on the medium, even in a case where the skew amount is greater than the threshold value, there is a case where the image can be printed on the medium. That is, in this case, if the printing is stopped, since the number of printing jobs that can be processed per unit time in the printer decreases, there is a problem in that the printing efficiency decreases.

### SUMMARY

An advantage of some aspects of the invention is to provide a printer that can suppress the decrease of the printing efficiency due to the transported medium being skewed.

Hereinafter, means of the invention and operation effects thereof will be described.

According to an aspect of the invention, there is provided a print control apparatus of a printer including a transport unit that transports a medium in a transport direction, a detection unit that can detect a skew amount of the medium, and a printing unit that performs printing on the medium based on a printing job. Furthermore, the print control apparatus includes a control unit that determines whether or not a print range of the printing job falls within a printable range of the medium calculated based on a result of detection by the detection unit in the transport direction and in a width direction crossing the transport direction, and that permits an execution of printing based on the printing job in a case where the print range falls within the printable range.

According to the configuration described above, in a case where the print range of the printing job falls within the printable range of the medium acquired based on the result of detection by the detection unit, the execution of printing based on the printing job is permitted. Therefore, even in a case were the skew amount of the medium increases with the increase of the transportation amount of the medium or the like, as long as the print range of the printing job falls within the printable range of the medium, printing on the medium is continued. Therefore, it is possible to suppress the decrease of the printing efficiency due to the skewing of the transported medium.

In the print control apparatus described above, it is preferable that the control unit can adjust an arrangement of the print range with respect to the printable range, and in a case where the print range does not fall within the printable range, when the print range falls within the printable range by adjusting the arrangement of the print range in the width direction, the control unit permits the execution of printing based on the printing job of which the print range is adjusted.

When the skew amount of the medium increases with the increase of the transportation amount of the medium, there is a case where the print range of the printing job does not fall within the printable range. Regarding this point, according to the configuration described above, when the print range falls within the printable range by adjusting the arrangement of the print range in the width direction with respect to the printable range, the printing based on the printing job of which the print range is adjusted is performed. Therefore, even in a situation where the skew amount of the medium increases, the printing based on the printing job can be continued, and thus, it is possible to further improve the printing efficiency.

In the print control apparatus described above, it is preferable that, in a case where there is a plurality of printing jobs, the control unit permits the execution of printing based on the printing job of which the print range falls within the printable range among the plurality of printing jobs, while limiting the execution of printing based on the printing job of which the print range does not fall within the printable range.

According to the configuration described above, in a case where there is a plurality of printing jobs, the execution of printing based on the printing job of which the print range falls within the printable range among the plurality of printing jobs is permitted. Therefore, in a case where the print range of a part of the printing job does not fall within the printable range among a plurality of printing jobs, limiting the execution of printing based on the entire printing jobs can be suppressed. In this point, it is possible to improve the printing efficiency. In addition, in a case where the print range of a part of the printing job does not fall within the printable range among a plurality of printing jobs, permitting the execution of printing based on the entire printing jobs can be suppressed. In this point, it is possible to suppress the occurrence of erroneous printing.

In the print control apparatus described above, it is preferable that, in a case where there is a plurality of printing jobs, the control unit determines whether or not a plurality of print ranges of a plurality of printing jobs falls within the printable range, and in a case where the plurality of print ranges of the plurality of printing jobs does not fall within the printable range, the control unit selects a printing job to be permitted to execute printing from the printing jobs of which the print range falls within the printable range among the plurality of printing jobs based on an input instruction.

According to the configuration described above, in a case where there is a plurality of printing jobs and in a case where the plurality of print ranges of the plurality of printing jobs does not fall within the printable range, a printing job to be permitted to execute printing is selected from the plurality of printing jobs based on, for example, the instruction input from the user. Therefore, for example, in a case where there are printing jobs having relevance to each other among the plurality of printing jobs, it is possible to execute printing based on the entirety of those printing jobs having the relevance, or not to execute printing based on the entirety of those printing jobs. In this way, it is possible to execute printing up to the printing job easy to be paused.

In the print control apparatus described above, it is preferable that the control unit can change a printing order of the plurality of printing jobs.

Some printing jobs have a large print range and some have a small print range depending on the content (image) desired to be printed. Therefore, depending on the size of the printable range of the medium, the print range of some printing jobs falls within the printable range and the print range of some printing jobs does not fall within the printable range.

According to the configuration described above, for example, in a case where there are N (a plurality of) printing jobs, in a situation where the printing up to the Nth printing job of which the print range falls within the printable range is executed and the print range of the (N+1)th printing job does not fall within the printable range, it is possible to change the printing order of the (N+1)th printing job and the printing job next to the (N+1)th printing job (for example, the (N+2)th printing job). Then, if the print range of the printing job next to the (N+1)th printing job falls within the printable range, the printing based on the printing job is executed. In this way, among the plurality of printing jobs, the number of printing jobs that can be continuously executed increases, and thus, it is possible to improve the printing efficiency.

In the print control apparatus described above, it is preferable that the printing job is for printing a plurality of images in a row on the medium in the transport direction, and when the print range of the printing job is referred to as an entire print range, the entire print range includes partial print ranges which are print ranges of each of the plurality of images, and in a case where the entire print range does not fall within the printable range, when the entire print range falls within the printable range by adjusting the arrangement of at least one partial print range among the plurality of partial print ranges in the width direction, the control unit permits the execution of printing based on the printing job of which the partial print range is adjusted.

Even in a case where the entire print range of the printing job is large and does not fall within the printable range, in some cases, it is possible to make the entire print range fall within the printable range by adjusting the arrangement of the plurality of the partial print ranges included in the entire print range of the printing job in the width direction. Therefore, according to the configuration described above, when the entire print range falls within the printable range by adjusting the arrangement of at least one of the plurality of partial print ranges among the plurality of partial print ranges in the width direction, the execution of printing based on the printing job of which the partial print range is adjusted is permitted. Therefore, according to this configuration, the number of printing jobs that can be continuously processed increases compared to the case of not adjusting the partial print range, and thus, it is possible to improve the printing efficiency.

In the print control apparatus described above, it is preferable that the control unit selects a partial print range of which the arrangement in the width direction is adjusted among the plurality of partial print ranges based on an input instruction.

When performing printing based on the printing job for printing a plurality of images, there is a case where it is not preferable that a print position (arrangement of the partial print range) of a plurality of images included in the printing job is changed. Regarding this point, according to the configuration described above, for example, it is possible to select the partial print range of which the arrangement is adjusted among the plurality of partial print ranges based on the instruction input from the user. Therefore, it is possible to execute the printing of the image of which a print position on the medium is not desired to be changed among a plurality of images included in the printing job, without changing the print position.

In the print control apparatus described above, it is preferable that, in a case where a skewing tendency of the medium changes when the printing is executed based on the printing job, the control unit executes at least one processing among notification processing that notifies of the change and stop processing that stops the printing.

In a case where a transportation failure does not occur during the transportation of the medium, a rate of increase of the skew amount to the increase of the transportation amount of the medium is less likely to change, and thus, the skewing tendency is less likely to change. On the other hand, in a case where the transportation failure occurs during the transportation of the medium, the rate of increase of the skew amount to the increase of the transportation amount of the medium is easy to change, and thus, the skewing tendency is easy to change. Then, when continuing the printing in a case where the transportation failure occurs, the content of printing according to the printing job is not printed in the printable range, and thus, the printing failure easily occurs. The transportation failure described here includes a case where the medium is clogged in the path where the medium is transported or a case where the transport resistance in the width direction is not uniform, and thus, the medium is transported in an inclined manner.

Regarding this point, according to the configuration described above, when the skewing tendency of the medium changes during the execution of printing based on the printing job, at least one processing among the notification processing and the stop processing is executed. Therefore, the execution of printing in a case where the transportation failure occurs is suppressed, and thus, it is possible to suppress the failure of printing.

According to another aspect of the invention, there is provided a printer includes the print control apparatus described above, a transport unit that transports a medium in a transport direction, a detection unit that can detect skewing of the medium; and a printing unit that performs printing on the medium based on a printing job.

According to the configuration described above, in the printer, it is possible to obtain the operation effects achieved by the print control apparatus described above.

In the printer described above, it is preferable that the printing unit includes a discharge unit that discharges an ink toward the medium, and the detection unit is provided in a range overlapping the discharge unit in the transport direction.

In the transport direction, there is a case where the skewing tendency of the medium changes at an upstream side and a downstream side. Therefore, in a case where the detection unit is provided at a position separated from the discharge unit in the transport direction, if the skewing tendency of the medium in the detection unit and the skewing tendency of the medium in the discharge unit are different from each other, even though the print range of any printing job does not fall within the printable range, there is a concern that the execution of printing based on the printing job is permitted. In this point, according to the configuration described above, since the detection unit and the discharge unit are provided in the overlapping range in the transport direction, it is possible to suppress the occurrence of the problems described above.

### BRIEF DESCRIPTION OF THE DRAWINGS

The invention will be described with reference to the accompanying drawings, wherein like numbers reference like elements.

FIG. 1 is a side view illustrating a schematic configuration of a printer according to a first embodiment.

FIG. 2 is a plan view illustrating a schematic configuration of the printer.

FIG. 3 is a front view illustrating a schematic configuration of a detection unit included in the printer.

FIG. 4 is a block diagram illustrating an electrical configuration of the printer.

FIG. 5 is a pattern diagram illustrating an aspect of transporting a medium in a state of being skewed.

FIG. 6 is a pattern diagram illustrating printable ranges of the media having skew amounts different from each other.

FIG. 7 is a flow chart illustrating a processing routine executed by a control unit for performing printing on the medium in the printer.

FIG. 8 is a pattern diagram illustrating an arrangement of a plurality of print ranges for a plurality of printing jobs in the printable range of the medium.

FIG. 9 is a pattern diagram illustrating an aspect of adjusting the arrangement of the print range for a second printing job.

FIG. 10 is a pattern diagram illustrating an aspect of adjusting the arrangement of the print range for a third printing job.

FIG. 11 is a pattern diagram illustrating an aspect of adjusting the arrangement of the print range for a fourth printing job.

FIG. 12 is a pattern diagram illustrating a state where printing based on the printing job in which the print range falls within in the printable range is entirely finished.

FIG. 13 is a flow chart illustrating a processing routine executed by the control unit for performing printing on the medium in the printer according to a second embodiment.

FIG. 14 is a pattern diagram illustrating an arrangement of a plurality of print ranges for a plurality of printing jobs in the printable range of the medium.

FIG. 15 is a flow chart illustrating a part of a processing routine executed by the control unit for performing printing on the medium in the printer according to a third embodiment.

FIG. 16 is a pattern diagram illustrating an arrangement of the print range of the printing job in the printable range on the medium.

FIG. 17 is a pattern diagram illustrating the medium in a state where the printing is executed based on a plurality of printing jobs of which the arrangement of the print range is adjusted.

### DESCRIPTION OF EXEMPLARY EMBODIMENTS

### First Embodiment

A printer according to a first embodiment will be described with reference to the drawings. The printer according to the present embodiment is an ink jet type large-format printer that forms an image on a medium such as a long sheet by ejecting an ink as an example of a liquid. In addition, the “image” in the present embodiment includes a pattern, and characters (sentence) in addition to a photo and a picture.

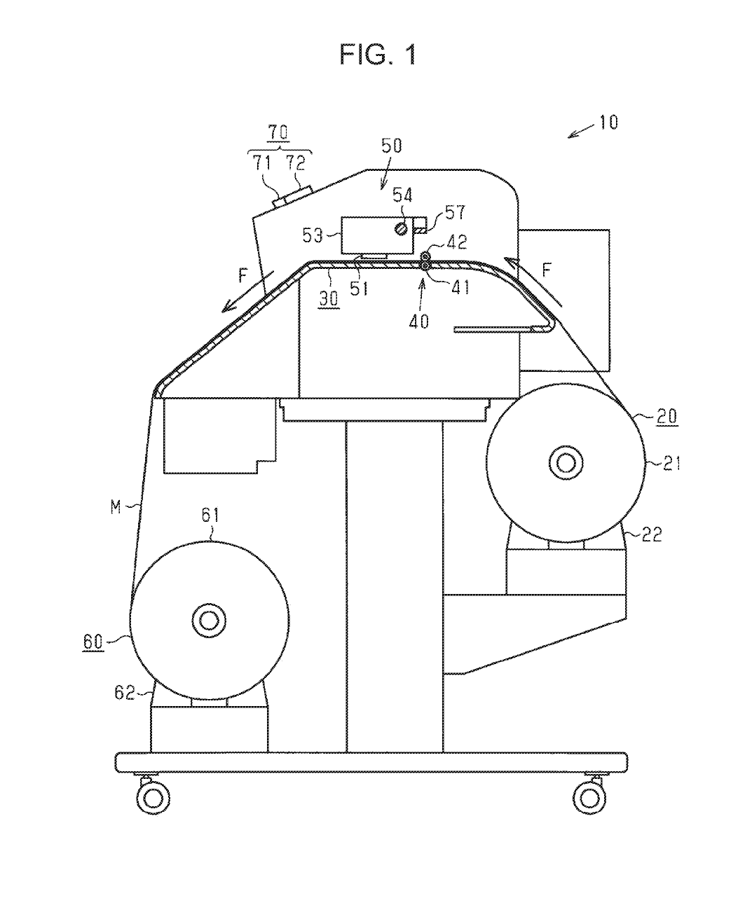

As illustrated in FIG. 1, a printer 10 includes a feeding unit 20 that feeds a medium M wound in a roll shape along a moving direction of the medium M, a supporter 30 that supports the medium M, a transport unit 40 that transports the medium M, a printing unit 50 that performs the printing on the medium M, a winding unit 60 that winds the medium M, and a setting unit 70 that performs various settings for the printer 10.

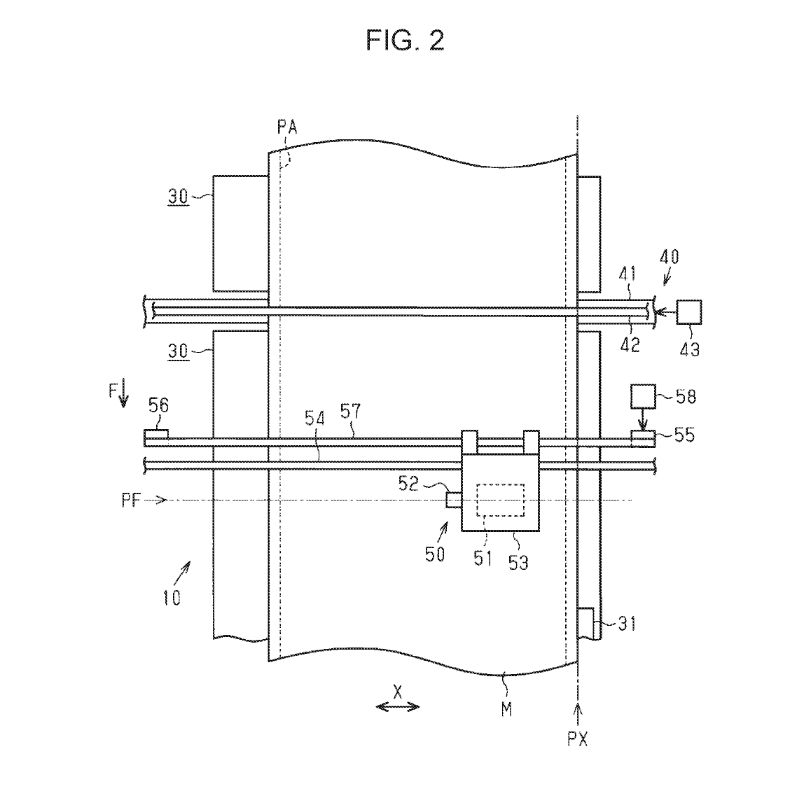

In the description below, a direction intersecting the direction of transporting the medium M is a width direction X (refer to FIG. 2) and a direction of transporting the medium M from the feeding unit 20 to the winding unit 60 is a transport direction F. In addition, in the present embodiment, one end (right end in FIG. 2) in the width direction X is defined as a “first end” and the other end (left end in FIG. 2) in the width direction X is defined as a “second end”. The width direction X is a direction intersecting the vertical direction of the printer 10.

As illustrated in FIG. 1, the feeding unit 20 includes a holding unit 22 that holds a roll body 21 that winds the medium M in a roll shape. Then, the feeding unit 20 performs the feeding of the medium M unwound from the roll body 21 by rotating the roll body 21 in one direction (a counter-clockwise direction in FIG. 1).

As illustrated in FIG. 1 and FIG. 2, the supporter 30 supports the medium M by being in contact with the rear surface of the medium M over the width direction X and the transport direction F. It is preferable that the supporter 30 has a color having a difference in reflectance compared to that of the medium M such as a black color. As illustrated in FIG. 2, a guide unit 31 is provided at the first end side in the width direction X of the supporter 30 and the position advanced in the transport direction F from the printing unit 50, which guides the transportation of the medium M by being in contact with the end surface of the first end side of the medium M.

As illustrated in FIG. 1 and FIG. 2, the transport unit 40 includes a drive roller 41 that rotates while being in contact with the rear surface of the medium M, a driven roller 42 that rotates while being in contact with the front surface of the medium M, and a transport motor 43 that drives the rotation of the drive roller 41. Then, the transport unit 40 transports the medium M toward the transport direction F by driving the transport motor 43 in a state where the medium M is pinched between the drive roller 41 and the driven roller 42.

As illustrated in FIG. 1 and FIG. 2, the printing unit 50 includes a discharge unit 51 (a discharge head) that discharges a droplet (ink), a detection unit 52 that can detect the medium M supported by the supporter 30, a carriage 53 that supports the discharge unit 51 and the detection unit 52, and a guide shaft 54 that supports the carriage 53 for a reciprocating movement in the width direction X. In addition, the printing unit 50 includes a drive pulley 55 provided on the first end side in the width direction X, a driven pulley 56 provided on the second end side in the width direction X, a timing belt 57 wound around the drive pulley 55 and the driven pulley 56, and a carriage motor 58 that drives the drive pulley 55.

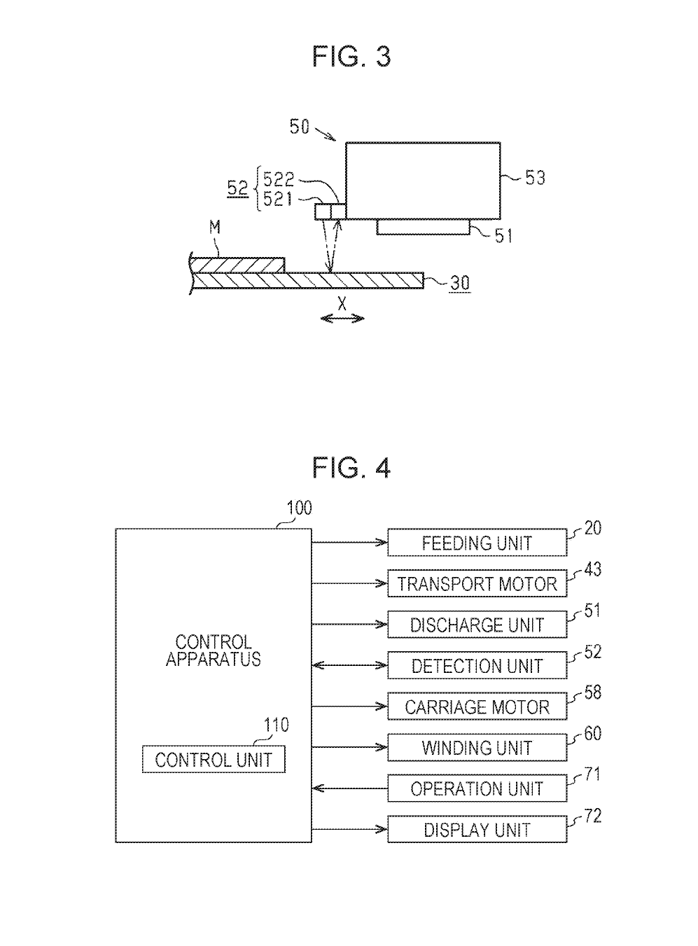

As illustrated in FIG. 3, the detection unit 52 includes a light projection unit 521 that projects a light toward a detection target (the supporter 30 and the medium M supported by the supporter 30) and a light reception unit 522 that receives the light reflected from the detection target. In addition, as illustrated in FIG. 2, the detection unit 52 is provided in a range overlapping the discharge unit 51 in the transport direction F. In other words, the detection unit 52 is provided so as to be adjacent to the discharge unit 51 in the width direction X.

Then, the printing unit 50 performs printing on the medium M based on a printing job input to the printer 10 from a user. Specifically, by driving the carriage motor 58, the printing unit 50 causes the timing belt 57 wound around the drive pulley 55 and the driven pulley 56 to rotate, and causes the carriage 53 linked to the timing belt 57 to move toward the width direction X.

In addition, when the carriage 53 moves toward the width direction X, the printing unit 50 performs printing on the medium M by causing the droplet to be discharged from the discharge unit 51 on the medium M supported by the supporter 30. The printing job is an instruction for printing including information relating to a printing content such as an image to be printed on the medium M, or information relating to a printing condition such as a position, a size, a range, and a number of times of printing the image.

In addition, when causing the carriage 53 to move toward the width direction X, the detection unit 52 of the printing unit 50 projects the light toward the detection target and receives the light reflected from the detection target. In this way, the detection unit 52 detects a distribution of the amount of the received light at a detection position in the width direction X. The detection position in the width direction X can be calculated based on an amount of rotation of an output shaft of the transport motor 43 or may be calculated based on an output result of the linear encoder by providing a linear encoder on the carriage 53.

As illustrated in FIG. 1, the winding unit 60 includes a holding unit 62 that holds a roll body 61 that winds the medium M in a roll shape. Then, the winding unit 60 performs winding of the print-finished medium M by rotating the roll body 61 in one direction (the counter-clockwise direction in FIG. 1).

As illustrated in FIG. 1, the setting unit 70 includes an operation unit 71 operated when the user instructs the printer 10 to start printing or performs various settings, and a display unit 72 that displays various information items of the printer 10. The operation unit 71 may be configured to include a plurality of buttons or the like. In addition, the display unit 72 may be configured to include a liquid crystal display or the like.

Next, an electrical configuration of the printer 10 will be described with reference to FIG. 4.

As illustrated in FIG. 4, the printer 10 includes a print control apparatus 100 that totally controls the entire printer. The print control apparatus 100 includes a control unit 110 that determines the executability of printing based on the printing job. In addition, the control unit 110 is a microcomputer that includes a CPU, a ROM and a RAM.

The detection unit 52 (the light reception unit 522) and the operation unit 71 are connected to an interface at an input side of the printer 10, and the feeding unit 20, the transport motor 43, the discharge unit 51, the detection unit 52 (the light projection unit 521), the carriage motor 58, the winding unit 60, and the display unit 72 are connected to an interface at an output side of the printer 10.

Then, the control unit 110 acquires information on what position the medium M is supported on the supporter 30 based on the distribution of the amount of the received light reflected in the width direction X which is the result of detection by the detection unit 52 (the light reception unit 522), or acquires information on the length of the medium M in the width direction X. For example, in a case where a reflection rate of the medium M is higher than a reflection rate of the supporter 30, an amount of reflected light at the detection position corresponding to the medium M in the width direction X becomes high and the amount of reflected light at the detection position corresponding to the supporter 30 becomes low. Therefore, the control unit 110 determines that the medium M is supported at the detection position in a case where the amount of reflected light at the detection position is large and determines that the medium M is not supported at the detection position in a case where the amount of reflected light at the detection position is small.

In addition, the control unit 110 determines whether or not to execute the printing based on the printing job input from the user based on the result of detection by the detection unit 52. In a case where there is a plurality of printing jobs, the control unit 110 processes the earlier printing job in order of timing of input to the printer 10.

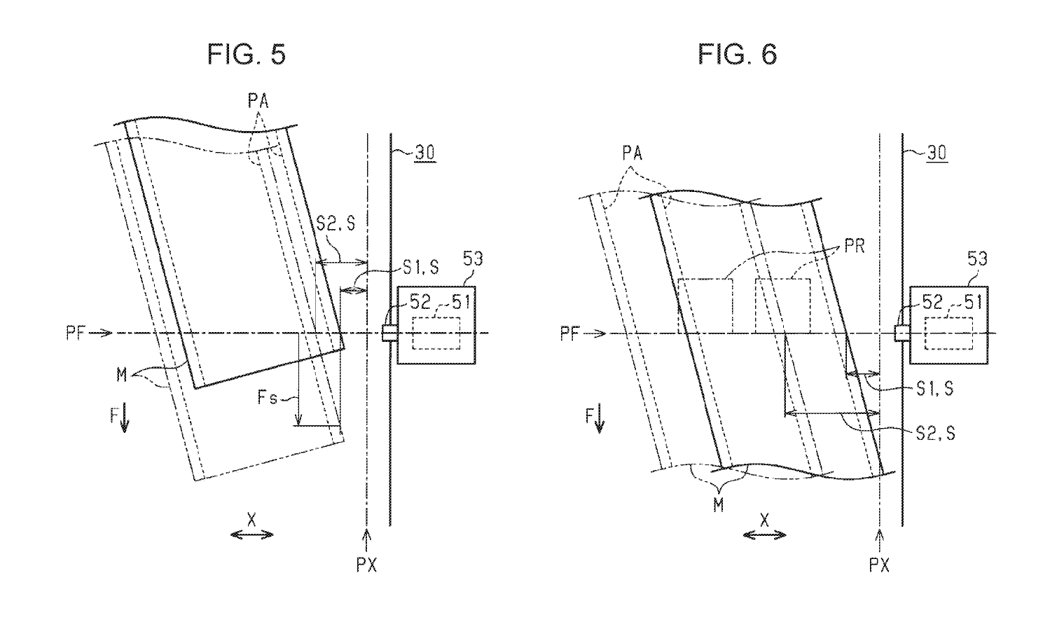

Next, a calculation method of a printable range PA of the medium M will be described with reference to FIG. 5.

In FIG. 5, a position of the end portion at the first end side in the width direction X of the supporter 30 is defined as a “width direction reference position PX”, and a position where the discharge unit 51 and the detection unit 52 supported by the carriage 53 reciprocally moves in the width direction X are scanning is defined as a “transport direction reference position PF”. At the transport direction reference position PF, a distance from the width direction reference position PX to the end surface of the first end side of the medium M is defined as a “skew amount S”.

As illustrated in FIG. 5, when calculating the printable range PA of the medium M, the control unit 110 acquires a first skew amount S1 at a first timing after the time when the medium M is set on the printer 10. Subsequently, the control unit 110 acquires a second skew amount S2 at a second timing which is a timing from the first timing to the time when the medium M is transported as much as a “reference transportation amount Fs” in the transport direction F. Then, the control unit 110 divides the difference between the first skew amount S1 and the second skew amount S2 by the reference transportation amount Fs, and then, calculates a skewing tendency value (hereinafter, referred to as “skewing tendency value ST”) indicating a ratio of increased amount of the skew amount S to the increased amount of the transportation amount of the medium M.

When the skewing tendency value ST calculated as described above is multiplied by an arbitrary transportation amount, the skew amount S with respect to the arbitrary transportation amount can be calculated. That is, the control unit 110 can figure out how much the skew amount S increases by how much the medium M is transported.

In addition, in the present embodiment, since a space having a predetermined width is provided on the medium M, the printable range PA has smaller range than the medium M by one round. Therefore, if the length and the skew amount S of the medium M in the width direction X can be determined, the control unit 110 can calculate the printable range PA by subtracting the predetermined width of the space.

Next, a relationship between the printable range PA of the medium M and a print range PR of the printing job will be described with reference to FIG. 6. In the printer 10, if the printing based on the printing job is performed under the situation where the medium M is skewed, the image desired to be printed according to the printing job is printed as being inclined with respect to the medium M. Therefore, it can be considered that the execution of printing may be limited when the skew amount S is equal to or greater than a predetermined determination value regardless of whether or not the print range PR of the printing job falls within the printable range PA of the medium M.

Incidentally, in a case where the execution of printing is limited as described above, even when the printing based on the printing job can be executed by making the print range PR of the printing job fall within the printable range PA of the medium M, there is a case where the printing is not executed or the user is requested to change the setting of the medium M on the printer 10.

Therefore, for example, in a case where there is no problem even if the image is inclined to the medium M such as a case where the printed image is cut out from the medium M, the number of printing jobs that can be processed by the printer 10 per unit time decreases by the execution of printing being limited. That is, the printing efficiency (throughput) of the printer 10 decreases.

Therefore, in the present embodiment, the printable range PA of the medium M is calculated and it is determined whether or not the print range PR of the printing job falls within the printable range PA of the medium M in the transport direction F and the width direction X based on the skew amount S acquired from the result of detection by the detection unit 52. Then, in a case where the print range PR falls within the printable range PA, the printing based on the printing job is permitted to be executed.

That is, regardless of whether or not the skew amount S is equal to or greater than the predetermined threshold value, if the print range PR of the printing job falls within the printable range PA, the printing based on the printing job is executed. For example, as illustrated by a solid line in FIG. 6, in a case where the skew amount S of the medium M is the first skew amount S1, since the print range PR illustrated by a dashed line falls within the printable range PA, the printing on the print range PR based on the printing job is executed.

On the other hand, as illustrated by a two-dot chain line in FIG. 6, the skew amount S of the medium M is the second skew amount S2 which is greater than the first skew amount S1, since the print range PR illustrated by the dashed line does not fall within the printable range PA, the printing on the print range PR based on the printing job cannot be executed.

Incidentally, by adjusting (moving) the arrangement of the print range PR of the printing job in the width direction X to the printable range PA of the medium M, the print range PR of the printing job can fall within the printable range PA. For example, as illustrated in FIG. 6, even in a case where the skew amount S of the medium M is the second skew amount S2, by moving the print range PR of the printing job to the second end side in the width direction X, the print range PR illustrated by a two-dot chain line falls within the printable range PA.

Therefore, in the present embodiment, in a case where the print range PR of the printing job does not fall within the printable range PA of the medium M, when the print range PR falls within the printable range PA by adjusting the arrangement of the print range PR in the width direction X, the control unit 110 permits to execute the printing based on the printing job in which the print range PR is adjusted.

In addition, in a case where there is a plurality of printing jobs, the control unit 110 permits to execute the printing based on the printing job in which the print range PR falls within the printable range PA among the plurality of printing jobs, and on the other hand, the execution of printing based on the printing job in which the print range PR does not fall within the printable range PA is limited. That is, even if the arrangement of the print range PR is adjusted in the width direction X, in a case where the print range PR does not fall within the printable range PA, the control unit 110 does not permit to execute the printing based on the printing job.

In addition, in a case where there is a plurality of printing jobs, since the control unit 110 processes the printing job in order of earlier input timing to the printer 10, there may be a case where the printing job of which the print range PR falls within printable range PA is present after the printing job in which the print range PR does not fall within the printable range PA.

Therefore, after the determination whether or not to execute the printing of the printing job in which the print range PR does not fall within the printable range PA, if the execution of printing based on the remaining printing job is limited or the user is requested to change the setting of the medium M in the printer 10, the printing based on the printing job after such printing job cannot be executed at all, and thus, the printing efficiency easily decreases.

Therefore, in the present embodiment, the control unit 110 can change the printing order of a plurality of printing jobs. Specifically, in a case where the execution of printing of the printing job in which the print range PR does not fall within the printable range PA among the plurality of printing jobs cannot be permitted, the control unit 110 changes the printing order of the printing job and the next printing job. Then, after changing the printing order, if the print range PR in the next printing job falls within the printable range PA, the control unit 110 permits the execution of printing based on the next printing job, and on the other hand, if the print range PR in the next printing job does not fall within the printable range PA, the execution of printing based on the next printing job is limited.

In addition, in a case of continuously executing the printing based on a plurality of printing jobs, there is a concern that a transportation failure such as a clogging of the medium M occurs on the transportation path of the medium M. In spite of the transportation failure occurring, if the printing on the medium M is continued, there is problem in that the droplet discharge performance of the discharge unit 51 deteriorates due to the discharge unit 51 being in contact with the medium M, or the image is printed to be protruded from the medium M.

Therefore, in the present embodiment, in a case where an initial skewing tendency value STi which is the skewing tendency value ST at the time of starting the transportation of the medium M is equal to or greater than a tendency determination value (hereinafter, referred to as “tendency determination value STth”), it is determined that the transportation failure occurs. In addition, in a case where the skewing tendency value ST is equal to greater than the tendency determination value STth at a predetermined timing when the printing based on a plurality of printing jobs is executed, that is, in a case where the skewing tendency value ST changes to a value equal to or greater than the tendency determination value STth also, it is determined that the transportation failure occurs. In the present embodiment, the predetermined timing described above is the timing immediately after the execution of the printing based on one printing job.

Here, the tendency determination value STth is a value for determining whether or not the medium M is transported in the skewed state to the extent not suitable for the execution of printing, or may be obtained by experiment in advance or may be arbitrarily set by the user. In this regard, in the present embodiment, the skewing tendency value ST is an example value indicating the skewing tendency of the medium M.

In addition, in a case where it can be determined that the transportation failure occurs, the control unit 110 executes notification processing that displays the gist of occurrence of the transportation failure on the display unit 72, and performs stop processing that stops the printing such that the printing is not performed.

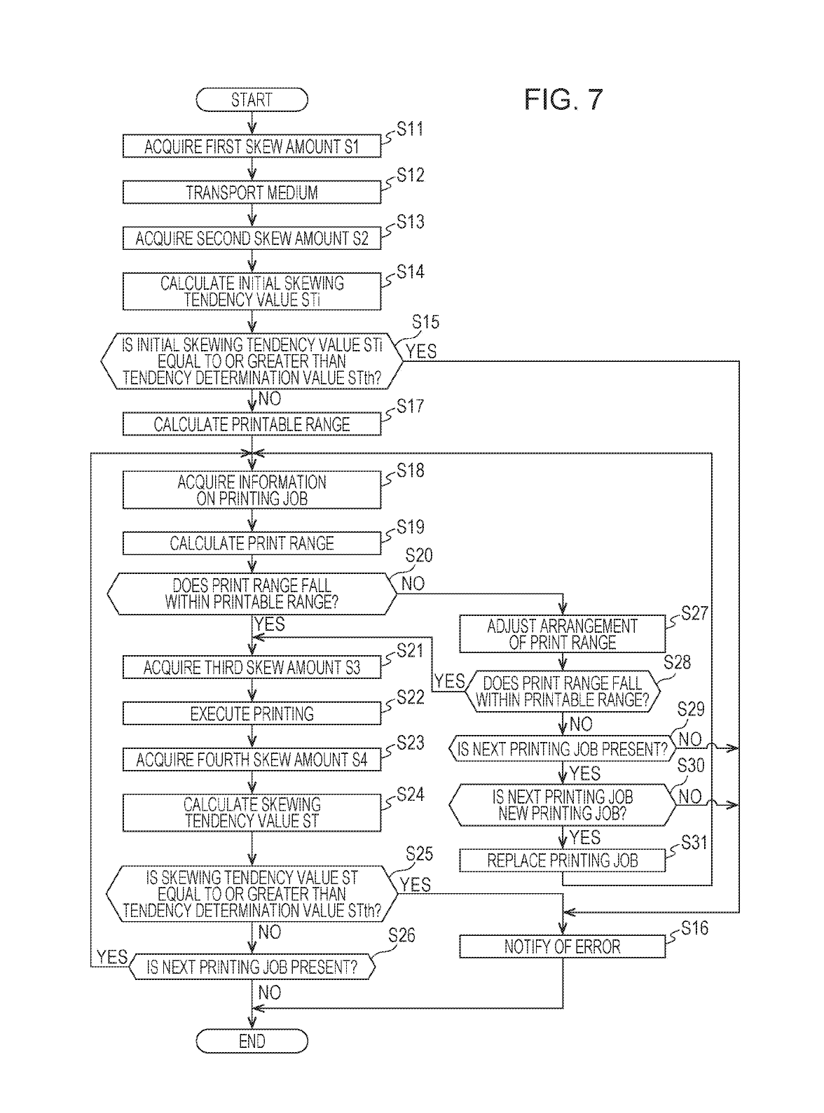

Next, a processing routine executed by the control unit 110 when the printing is performed on the medium M will be described with reference to a flowchart illustrated in FIG. 7. The processing routine herein is a processing routine executed after a printing job is input to the printer 10 in a state where the medium M is set on the printer 10 by the user.

As illustrated in FIG. 7, in the processing routine herein, the control unit 110 acquires the skew amount S of the medium M (the first skew amount S1) based on the result of detection by the detection unit 52 (STEP S11). Specifically, the control unit 110 moves the carriage 53 in the scanning direction and acquires the first skew amount S1 of the medium M based on the distribution of the amount of the received light in the width direction X detected by the detection unit 52.

Subsequently, the control unit 110 transports the medium M in the transport direction F as much as the reference transportation amount Fs (STEP S12), and acquires the skew amount S of the medium M (the second skew amount S2) again based on the result of detection by the detection unit 52 (STEP S13). Then, the control unit 110 calculates the initial skewing tendency value STi by dividing the increased amount of the skew amount S which can be obtained by subtracting the first skew amount S1 from the second skew amount S2, by the reference transportation amount Fs (STEP S14).

Subsequently, the control unit 110 determines whether or not the initial skewing tendency value STi is equal to or greater than the tendency determination value STth (STEP S15), and in a case where the initial skewing tendency value STi is equal to or greater than the tendency determination value STth (Yes in STEP S15), the control unit 110 causes the display unit 72 to notify of the error (STEP S16).

The content of the error notification in this case (Yes in STEP S15) is to urge the user to change the setting of the medium M on the printer 10 because the medium M is skewed to the extent not suitable for printing. In addition, in a case where STEP S16 is executed, processing that executes the printing in STEP S22 below is not executed. In this regard, in the present embodiment, the processing in STEP S16 corresponds to an example of “notification processing” and “stop processing”. Thereafter, the control unit 110 temporarily ends the present processing routine.

In previous STEP S15, in a case where the initial skewing tendency value STi is smaller than the tendency determination value STth (No in STEP S15), the control unit 110 calculates the printable range PA based on the initial skewing tendency value STi (STEP S17).

Then, the control unit 110 acquires the information on the printing job (STEP S18). In STEP S18, in a case where there is only one printing job, the control unit 110 acquires the information on the printing job, and in a case where there is a plurality of printing jobs, acquires the information on the printing job which is firstly input to the printer 10 among the plurality of printing jobs. That is, the printing jobs are sequentially stored in a queue provided in the RAM in the control unit 110 in order of the queue (waiting matrix).

Subsequently, the control unit 110 acquires the print range PR of the printing job from the information on the printing job (STEP S19), and determines whether or not the print range PR falls within the printable range PA (STEP S20). In a case where the print range PR falls within the printable range PA (Yes in STEP S20), the control unit 110 acquires the skew amount S (a third skew amount S3) at the timing before the execution of printing (STEP S21), and executes the printing based on the printing job acquired in STEP S18 (STEP S22). That is, the control unit 110 causes the discharge operation of moving the discharge unit 51 in the width direction X and discharging the ink from the discharge unit 51 toward the medium M and the transport operation of transporting the medium M in the transport direction F as much as the unit transportation amount, to be alternately performed. In this way, the control unit 110 causes the printing content (image) in the printing job to be printed on the medium M.

The control unit 110 acquires a skew amount S (a fourth skew amount S4) at the timing after finishing the execution of printing (STEP S23), and calculates the skewing tendency value ST based on the third skew amount S3, the fourth skew amount S4, and the transportation amount of the medium M caused the execution of STEP S22 (STEP S24). Specifically, the control unit 110 calculates the skewing tendency value ST by dividing the increased amount of the skew amount S obtained by subtracting the third skew amount S3 from the fourth skew amount S4, by the transportation amount of the medium M caused by the printing based on the printing job.

Subsequently, the control unit 110 determines whether or not the skewing tendency value ST is equal to or greater than the tendency determination value STth (STEP S25). In a case where the skewing tendency value ST is smaller than the tendency determination value STth (No in STEP S25), the printing based on the most recent printing job is construed as finished normally, and then, the control unit 110 determines whether or not a next printing job is present (STEP S26). In a case where a next printing job is not present (No in STEP S26), that is, in a case where the execution of the entire printing jobs is finished, the control unit 110 temporarily ends the present processing routine.

On the other hand, in a case where the next printing job is present (Yes in STEP S26), that is, in a case where the execution of the entire printing jobs is not finished, in order to execute the printing based on the next printing job, the control unit 110 moves the process to previous STEP S18. In a case where the process is moved to STEP S18, the printing job executed normally is erased from the RAM (queue) of the control unit 110.

In previous STEP S25, in a case where the skewing tendency value ST is equal to or greater than the tendency determination value STth (Yes in STEP S25), that is, in a case where the skewing tendency of the medium M is changed, the control unit 110 moves the process to STEP S16. In this case (Yes in STEP S25), since there is a possibility that the most recent printing based on the printing job is not finished normally, it is desired that the control unit 110 does not erase the printing job from the RAM (queue) of the control unit 110.

In previous STEP S20, in a case where the print range PR does not fall within the printable range PA (No in STEP S20), the control unit 110 adjusts the arrangement of the print range PR of the printing job in the width direction X with respect to the printable range PA of the medium M (STEP S27), and determines whether or not the adjusted print range PR falls within the printable range PA (STEP S28).

Here, the adjustment of the arrangement of the print range PR and the determination whether or not the print range PR falls within the printable range PA may be performed as follows. For example, the adjustment and the determination may be realized by alternately performing the processing that allocates the coordinates on four corners of the rectangular-shaped print range PR and four corners of the rectangular-shaped printable range PA and that moves the print range PR little by little (for example, one pixel at a time) in the width direction X, and the processing that determines whether or not the coordinates of the four corners of the print range PR falls within the printable range PA.

That is, by moving the print range PR little by little in the width direction X, it is sufficient that the determination in STEP S28 may be “Yes” when four corners of the print range PR falls within the printable range PA. In addition, even when the processing that moves the print range PR little by little in the width direction X is repeatedly performed, if the coordinates of four corners of the print range PR does not fall within the printable range PA, the determination in STEP S28 may be “No”. The direction the print range PR is moving may be a direction toward the second end side in the width direction X in a case where the skew amount S increases due to the transportation of the medium M, and may be a direction toward the first end side in the width direction X in a case where the skew amount S decreases due to the transportation of the medium M.

In a case where the adjusted print range PR falls within the printable range PA (Yes in STEP S28), the control unit 110 moves the process to STEP S21. In this case, the printing based on the printing job of which the print range PR is adjusted is executed. On the other hand, in a case where the print range PR after the adjustment does not fall within the printable range PA (No in STEP S28), the control unit 110 determines whether or not the next printing job is present (STEP S29).

In a case where the next printing job is not present (No in STEP S29), that is, in a case where the current printing job is the final printing job, the control unit 110 moves the process to previous STEP S16. The content of an error notification in this case (No in STEP S29) is to urge the user to change the setting of the medium M on the printer 10 because, there is a printing job for which the printing cannot be executed in the current skew amount S of the current medium M.

On the other hand, in a case where the next printing job is present (Yes in STEP S29), the control unit 110 determines whether or not the next printing job is a new printing job (STEP S30). Here, the new printing job means a printing job on which the determination of executability of printing the printing job is not performed yet, that is, the processing items in STEP S18 to S20 are not executed yet.

In a case where the next printing job is a new printing job (Yes in STEP S30), the control unit 110 replaces the printing job (STEP S31), and moves the process to STEP S18. Specifically, the control unit 110 changes the printing order of the first printing job (current printing job) in the queue of the RAM of the control unit 110 to be final, and advances the printing order of other printing jobs by “1” respectively.

On the other hand, in a case where the next printing job is not a new printing job (No in STEP S30), that is, the determination of the executability of printing is performed on the entire printing jobs, and in a case where there remains the printing job to which the execution of printing is limited, the control unit 110 moves the process to STEP S16. The error notification in this case (No in STEP S30), for example, is to urge the user to change the setting of the medium M on the printer 10 because there is a plurality of printing jobs of which the printing cannot be executed in the current skew amount S of the current medium M.

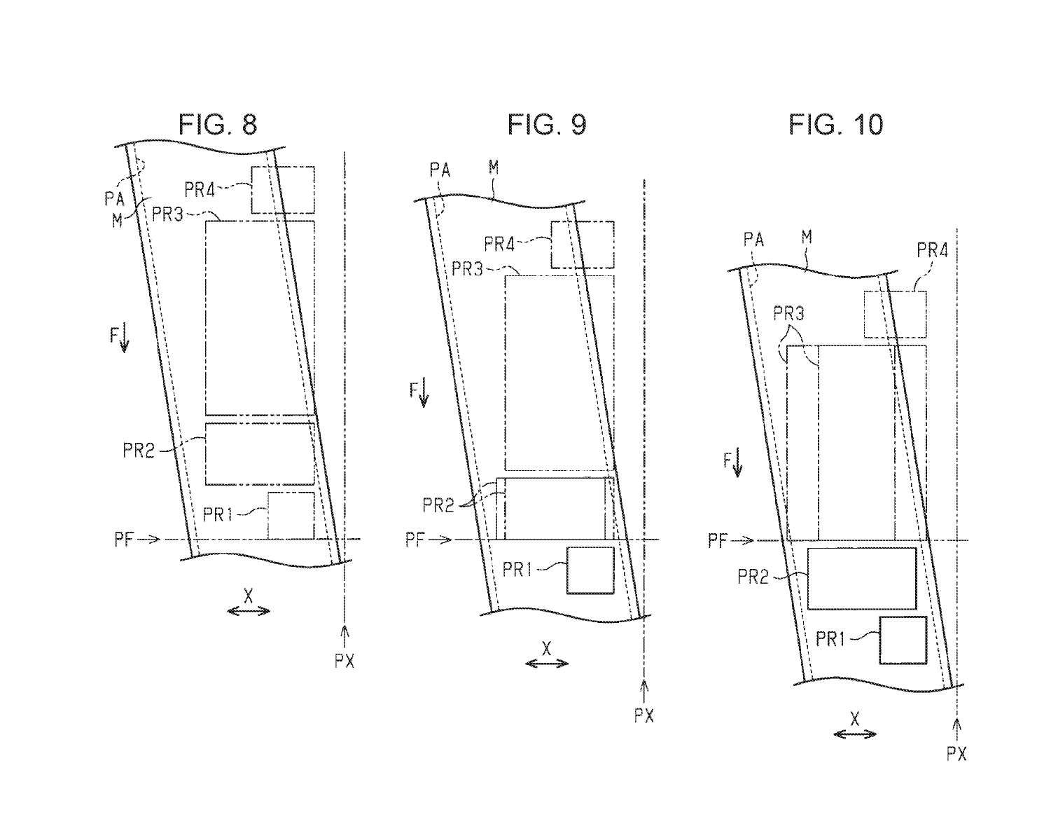

Next, actions of the printer 10 according to the first embodiment will be described with reference to FIG. 8 to FIG. 12. In FIG. 8 to FIG. 12, the arrangements of print ranges PR of a plurality of printing jobs with respect to the printable range PA of the skewed medium M are illustrated. In addition, in FIG. 8 to FIG. 12, the print range PR of the printing job for which the printing is finished are illustrated by solid lines, the print ranges PR of the printing job of which the adjustment of the arrangement is performed is illustrated by chain lines, and the printing job of which adjustment of the arrangement is not performed, that is, print range PR of the printing job waiting for executing the printing, is illustrated by two-dot chain lines.

Here, in the printer 10, in a case of starting the printing based on a plurality of printing jobs, the skewing tendency value ST is calculated. Subsequently, the printable range PA is calculated based on the skewing tendency value ST. Then, the executability of printing based on the printing job is determined in order of inputting the printing jobs to the printer 10. That is, the executability of printing is determined in order of the first printing job, the second printing job, the third printing job, and the fourth printing job.

As illustrated in FIG. 8, since a print range PR1 of the first printing job falls within the printable range PA, the printing based on the first printing job is executed while the arrangement of the print range PR1 is not adjusted. Subsequently, the executability of printing based on the second printing job is determined.

As illustrated in FIG. 9, since a print range PR2 of the second printing job does not fall within the printable range PA, the arrangement of the print range PR2 is adjusted. Specifically, the arrangement of the print range PR2 of the second printing job is adjusted so as to move from the position illustrated by a two-dot chain line to the position illustrated by a chain line in FIG. 9. As a result, since the print range PR2 of the second printing job of which the arrangement is adjusted falls within the printable range PA, the printing based on the second printing job of which the print range PR2 is adjusted is executed. Subsequently, the executability of printing based on the third printing job is determined.

As illustrated in FIG. 10, since a print range PR3 of the third printing job does not fall within the printable range PA, similarly to the second printing job, the arrangement of the print range PR3 is adjusted. Specifically, the arrangement of the print range PR3 of the third printing job is adjusted so as to move from the position illustrated by a two-dot chain line to the position illustrated by a chain line in FIG. 10. Incidentally, since the print range PR3 of the third printing job of which the arrangement is adjusted does not fall within the printable range PA, the printing based on the third printing job is limited. Therefore, the printing order of the third printing job and the next fourth printing job is changed, and the executability of printing based on the fourth printing job is determined.

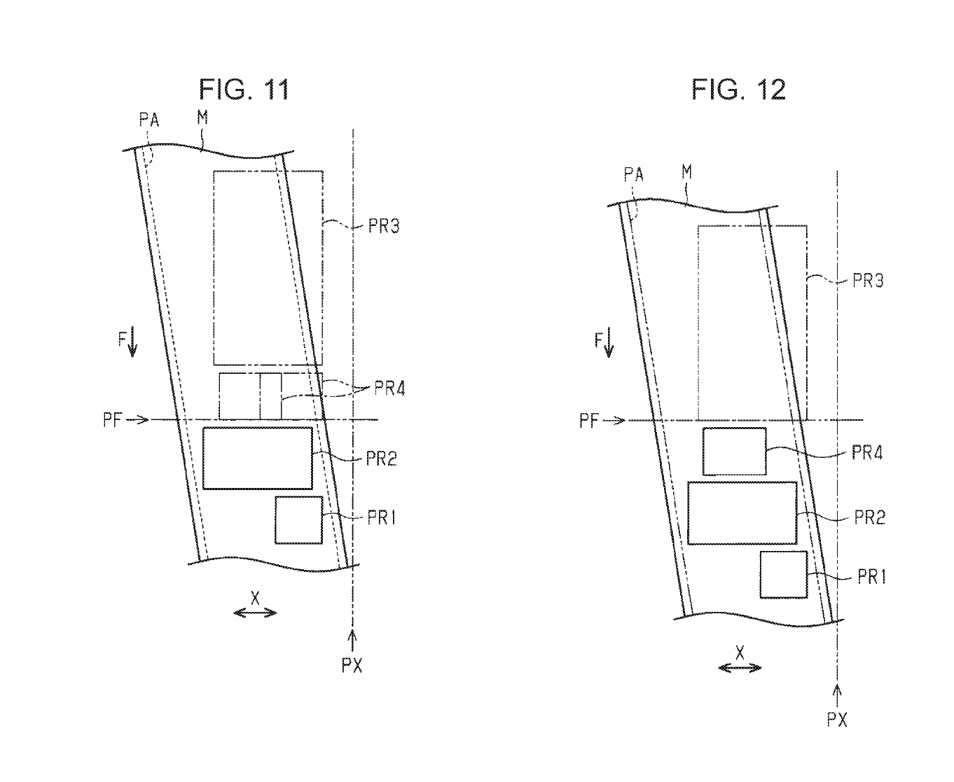

As illustrated in FIG. 11, since a print range PR4 of the fourth printing job does not fall within the printable range PA, similarly to the second printing job and the third printing job, the arrangement of the print range PR is adjusted. Specifically, the arrangement of the print range PR4 of the fourth printing job is adjusted so as to move from the position illustrated by a two-dot chain line to the position illustrated by a chain line in FIG. 9. As a result, since the print range PR4 of the fourth printing job of which the arrangement is adjusted falls within the printable range PA, the printing based on the fourth printing job of which the print range PR4 is adjusted is executed.

In this way, as illustrated in FIG. 12, the printing based on the first printing job, second printing job, and the fourth printing job of which the print ranges PR1, PR2, and PR4 fall within the printable range PA respectively is executed. On the other hand, the printing based on the third printing job of which the print range PR3 does not fall within the printable range PA is not executed. Therefore, since the printing of entire printable printing job can be executed, the decrease of the printing efficiency can be suppressed.

In addition, when the printing based on the fourth printing job is finished, under the state where the execution of printing based on the third printing job is limited, the fact that the printing based on the third printing job cannot be executed due to the skewing of the medium M is notified. Thereafter, when the medium M is reset in the printer 10 so as not to skew and the restarting of the printing is instructed by the user, the printing based on the third printing job is executed.

According to the first embodiment described above, the effects described below can be achieved.

1. In a case where the print range PR of the printing job falls within the printable range PA of the medium M, the execution of printing based on the printing job is permitted. Therefore, even in a case were the skew amount S of the medium M increases with the increase of the transportation amount of the medium M, as long as the print range PR of the printing job falls within the printable range PA of the medium M, the printing on the medium M is continued. Therefore, it is possible to suppress the decrease of the printing efficiency due to the skewing of the transported medium M.

2. When the print range PR falls within the printable range PA by adjusting the arrangement of the print range PR in the width direction X with respect to the printable range PA, the execution of printing based on the printing job of which the print range PR is adjusted is permitted. Therefore, even in the situation where the skew amount S of the medium M increases, the printing based on the printing job can be continued, and thus, it is possible to further improve the printing efficiency.

As an operation environment of the printer 10, there is a case where a medium M having a maximum length in the width direction X is set in the printer 10 regardless of the print range PR of the printing job. In this case, since the printable range PA has a margin in the width direction X even if the skew amount S of the medium M increases, by the adjustment of the print range PR in the width direction X, there can be many printing jobs of which the printing becomes executable. Therefore, in a case where a medium M having a printable range PA longer than the print range PR in the width direction X is set in the printer 10, it is possible to further improve the printing efficiency.

3. Among a plurality of printing jobs, the execution of printing based on the printing job of which the print range PR falls within the printable range PA is permitted while the execution of printing based on the printing job of which the print range PR does not fall within the printable range PA is limited. Therefore, in a case where the print range PR of a part of the printing job (for example, the third printing job) does not fall within the printable range PA among a plurality of printing jobs, limiting the execution of printing based on the entire printing jobs can be suppressed. In this point, it is possible to improve the printing efficiency. In addition, in a case where the print range PR of a part of the printing job (for example, the third printing job) does not fall within the printable range PA among a plurality of printing jobs, permitting the execution of printing based on the entire printing jobs including printing job can be suppressed. In this point, it is possible to suppress the occurrence of erroneous printing.

4. Among a plurality of printing jobs, under the situation where the printing is executed up to an Nth printing job and the print range PR of an (N+1)th printing job (for example, the third printing job) does not fall within the printable range PA, the printing order of the (N+1)th printing job and the (N+2)th printing job (for example, the fourth printing job) is changed. Therefore, if the print range PR of the (N+2)th printing job falls within the printable range PA, the printing based on the (N+2)th printing job is executed. In this way, the number of printing jobs that can be continuously executed increases when the execution of printing based on the (N+1)th printing job is limited compared to the case where the execution of printing based on the entire printing jobs subsequent to the (N+1)th printing job is limited, and thus, it is possible to improve the printing efficiency.

5. When the printing based on the printing job is executed, if the skewing tendency value ST of the medium M is equal to or greater than the tendency determination value STth, the execution of printing is limited and an error is notified. Therefore, the execution of printing in a state of the transportation error occurring can be suppressed, and thus, it is possible to suppress the occurrence of the erroneous printing.

6. In the transport direction F, there is a case where the skewing tendency of the medium M changes at an upstream side and a downstream side. Therefore, in a case where the detection unit 52 is provided at a position separated from the discharge unit 51 in the transport direction F, if the skewing tendency of the medium M in the detection unit 52 and the skewing tendency of the medium M in the printing unit 50 are different from each other, even though the print range PR of any printing job does not fall within the printable range PA, there is a concern that the execution of printing based on the printing job may be permitted. In this point, according to the embodiment described above, since the detection unit 52 and the printing unit 50 are provided in the overlapping range in the transport direction F, it is possible to suppress the occurrence of erroneous printing.

### Second Embodiment

Next, a printer 10 according to a second embodiment will be described with reference to the drawings. In the description below, points different from that in the first embodiment are mainly described. The same reference signs will be given to the same configuration elements as that in the first embodiment, and the description thereof will not be repeated.

There is a case where two or more printing jobs having a relevance to each other is included in a plurality of printing jobs put into the printer 10. For example, there is a case where the printing jobs is included such as printing jobs having a common printing content (image) or the printing jobs having a common print range PR. In this case, if the print range PR of the one printing job among the plurality of printing jobs does not fall within the printable range PA, there is a case where the printing of a plurality of printing jobs having a relevance to each other is stopped during the printing.

On the other hand, when executing the printing based on a plurality of printing jobs, there is a case where the user does not want to stop the printing of a plurality of printing jobs having a relevance to each other during the printing or wants to execute the printing up to the printing job easy to be paused.

Therefore, in the second embodiment, when there is a plurality of printing jobs, the control unit 110 determines whether or not a plurality of print range PR of the plurality of printing jobs falls within the printable range PA, and in a case where a plurality of (entire of the) print ranges PR of the plurality of printing jobs does not fall within the printable range PA, receives an instruction input from the user. Then, the control unit 110 selects a printing job which is permitted to execute the printing from the printing jobs of which the print range PR falls within the printable range PA among the plurality of printing jobs based on the instruction input from the user.

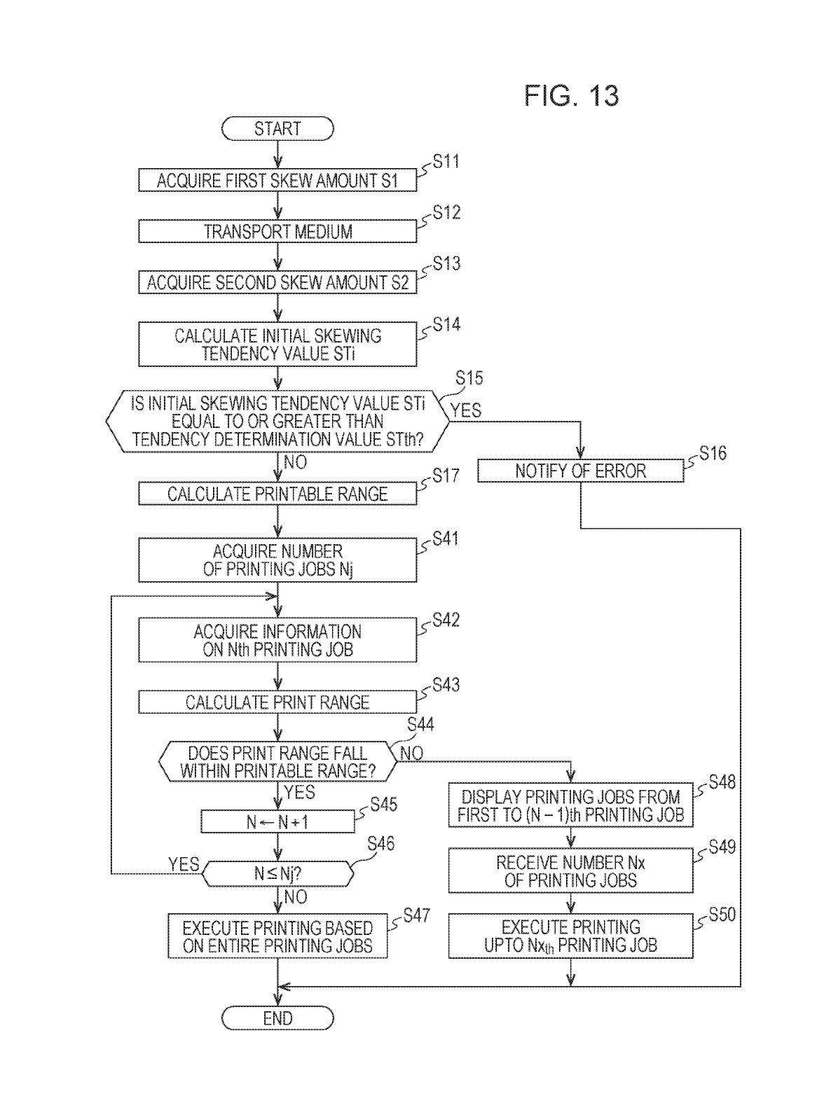

Next, a processing routine executed by the control unit 110 when the printing is performed based on a plurality of printing jobs will be described with reference to a flowchart illustrated in FIG. 13.

As illustrated in FIG. 13, in the processing routine, when the printable range PA is calculated (STEP S17), the control unit 110 acquires the number of printing jobs Nj input to the printer 10 (STEP S41). In STEP S41, in a case where the number of printing jobs Nj is less than “0 (zero)”, it is assumed that the control unit 110 temporarily ends the present processing routine.

Subsequently, the control unit 110 acquires information on the Nth printing job (STEP S42). Here, the variable N is assumed to be set to “1” when the execution in the processing routine starts. That is, in a case where the first processing in STEP S42 is executed after starting the processing routine, the information relating to the first printing job is acquired.

Then, the control unit 110 acquires the print range PR of the Nth printing job (STEP S43) based on the information on the Nth printing job acquired by executing the previous STEP S42, and determines whether or not the print range PR of the Nth printing job falls within the printable range PA (STEP S44). In a case where the print range PR of the Nth printing job falls within the printable range PA (Yes in STEP S44), the control unit 110 increases the variable N by an increment of “1” (STEP S45), and determines whether or not the variable N is equal to or smaller than the number of printing jobs Nj (STEP S46).

In a case where the variable N is equal to or smaller than the number of printing jobs Nj (Yes in STEP S46), the control unit 110 moves the process to STEP S42. In this case, the processing subsequent to STEP S42 is executed for the next printing job. In a case where the variable N is equal to or greater than 1, and in a case where the processing subsequent to STEP S42 is executed, it is determined whether or not the print range PR of the Nth printing job falls within the printable range PA in which the transportation amount of the medium M due to the execution of printing based on from the first printing job to the (N−1)th printing job is considered.

On the other hand, in a case where the variable N is greater than the number of printing jobs Nj (No in STEP S46), that is, in a case where the print ranges PR of the entire printing jobs fall within the printable range PA (Yes in STEP S44), the control unit 110 sequentially executes the printing based on the entire printing jobs (STEP S47). Then, when the execution of all the printing is finished, the control unit 110 temporarily ends the present processing routine.

On the other hand, in previous STEP S44, in a case where the print range PR of the Nth printing job does not fall within the printable range PA (No in STEP S44), the control unit 110 causes the printing jobs from the first printing job to the (N−1)th printing job to be displayed on the display unit 72 (STEP S48). In displaying the printing jobs on the display unit 72, only the numbers of printing jobs may be displayed or the thumbnails of the images may be displayed. Then, the control unit 110 receives the printing job number Nx input by the user via the operation unit 71 (STEP S49).

Here, in STEP S49, when printing jobs are displayed on the display unit 72, a message causing the user to select which printing job among the printing jobs from the first printing job to the (N−1)th printing job the printer executes printing up to, is displayed together. Then, the user checking the display inputs the printing job number Nx (Nx is “1” to “N−1) desired to be printed via the operation unit 71. That is, the printing job number Nx received in STEP S49 is a printing job number indicating up to which printing job the user desires to execute the printing among a plurality of printing jobs. In this point, in the present embodiment, the printing job number Nx is an example of an instruction input to the control unit 110.

Then, the control unit 110 executes the printing from the first printing job to the Nxₜₕ printing job (STEP S50), and then, temporarily ends the present processing routine. In a case where STEP S50 is executed, the printing of the printing jobs from the (Nx+1)th printing job to the Njₜₕ printing job are not executed. Therefore, the printer 10 may be caused to display a message requesting the user to change the setting of the medium M on the display unit 72 such that the printing based on the remaining printing job can be executed.

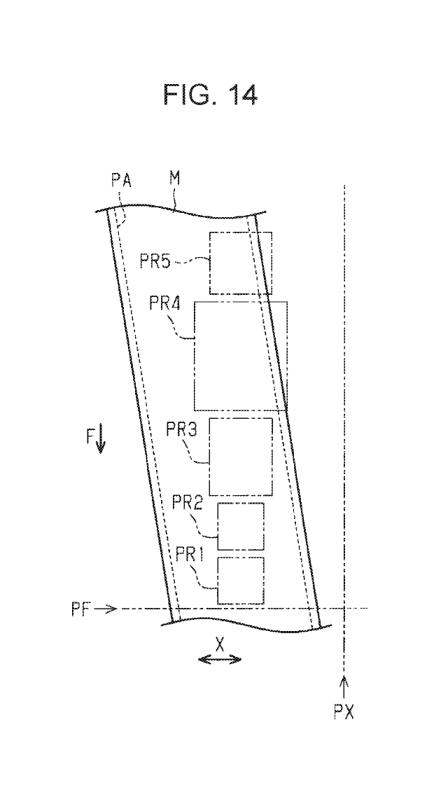

Next, actions of the printer 10 according to the second embodiment will be described with reference to FIG. 14. In FIG. 14, the arrangements of print ranges PR of a plurality of printing jobs with respect to the printable range PA of the skewed medium M are illustrated. In FIG. 14, the print range PR of the printing job waiting for the execution of printing is illustrated in two-dot chain line.

In the printer 10, in a case of starting the printing based on a plurality of printing jobs, the skewing tendency value ST is calculated. Subsequently, the printable range PA is calculated based on the skewing tendency value ST. Then, the executability of printing based on the printing job is determined in order of inputting the printing jobs to the printer 10. That is, the executability of printing is determined in order of the first printing job, the second printing job, the third printing job, the fourth printing job, and the fifth printing job.

As illustrated in FIG. 14, the print ranges PR1, PR2, and PR3 of the first printing job, the second printing job, and the third printing job respectively fall within the printable range PA while the print ranges PR4 and PR5 of the fourth printing job and the fifth printing job respectively do not fall within the printable range PA. Therefore, a message causing the user to select which printing job among the printing jobs from the first printing job to the third printing job the printer executes the printing up to, is displayed on the display unit 72 of the printer 10.

Here, in a case where the execution of printing up to the second printing job which has the same print range PR as the first printing job is considered to be desired, a message indicating that desire is input to the printer 10 via the operation unit 71. That is, the printing job number Nx is “2”. Then, the printer 10 executes the printing based on the first printing job and the second printing job, and the printing based on the third printing job of which the print range PR3 actually falls within the printable range PA is not executed.

In addition, the printer 10 does not execute the printing based on the fourth printing job and the fifth printing job of which the print ranges PR4 and PR5 do not fall within the printable range PA, either. In this way, the printing can be executed up to the printing job which is considered by the user easy to be paused.

According to the second embodiment, the effects described below can be achieved in addition to the effects 1, 3, and 6 according to the first embodiment.

7. In a case where there is a plurality of printing jobs, in a case where the print range PR of the at least one printing job among the plurality of printing jobs does not fall within the printable range PA, which printing job the execution of printing is permitted up to, is selected based on the instruction input by the user. Therefore, it is possible to execute the printing up to the printing job which is considered by the user easy to pause.

### Third Embodiment

Next, a printer 10 according to a third embodiment will be described with reference to the drawings. In the description below, points different from that in the first embodiment are mainly described. The same reference signs will be given to the same configuration elements as that in the first embodiment, and the description thereof will not be repeated.

In the printing job described in the first embodiment and the second embodiment, there is a printing job for printing a plurality of images in a row in the transport direction F on the medium M. For example, such a printing job includes a printing job for printing the same images in multiple times. Here, the print range of the printing job is assumed to an “entire print range PRT” and a print range for each of a plurality of images desired to be printed by the printing job is a “partial print range PRP”. That is, the entire print range PRT includes a plurality of partial print ranges PRP.

Then, even in a case where the entire print range PRT of the printing job does not fall within the printable range PA, in some cases, it is possible to make the entire print range PRT fall within the printable range PA by adjusting the arrangement of the plurality of the partial print ranges PRP included in the entire print range PRT of the printing job in the width direction X. Therefore, in the third embodiment, when the entire print range PRT falls within the printable range PA by adjusting the arrangement of at least one of the plurality of partial print ranges PRP among the plurality of partial print ranges PRP in the width direction X, control unit 110 permits the execution of printing based on the printing job of which the partial print range PRP is adjusted.

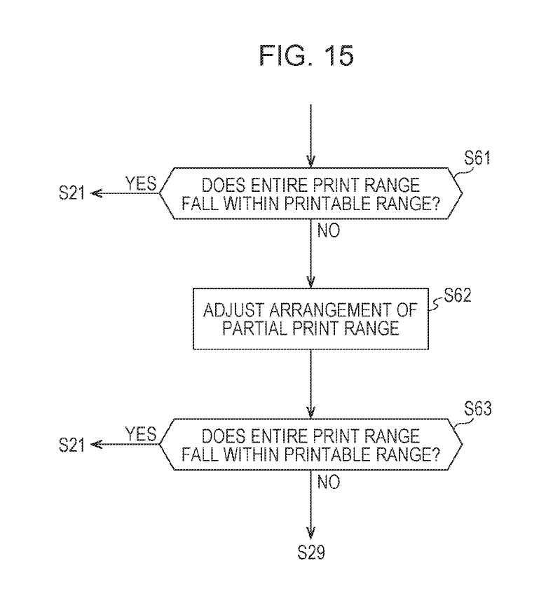

Next, a processing routine executed by the control unit 110 for executing the printing based on the printing job for printing a plurality of images in a row in the transport direction F will be described with reference to a flowchart illustrated in FIG. 15. In the flowchart illustrated in FIG. 15, processing will be mainly described, which is different from that in the flowchart illustrated in FIG. 7.

As illustrated in FIG. 15, in the present processing routine, the control unit 110 determines whether or not the entire print range PRT falls within the printable range PA (STEP S61). In a case where the entire print range PRT falls within the printable range PA (Yes in STEP S61), the control unit 110 moves the process to STEP S21 for executing the printing based on the printing job.

On the other hand, in a case where the entire print range PRT does not fall within the printable range PA (No in STEP S61), the control unit 110 adjusts the arrangement of the partial print range PRP in the width direction X with respect to the printable range PA (STEP S62), and determines whether or not the entire print range PRT of which the arrangement is adjusted by the adjustment of the partial print range PRP falls within the printable range PA (STEP S63).

The adjustment of the arrangement of the entire print range PRT and the determination whether or not the partial print range PRP falls within the printable range PA may be similar to the arrangement of the print range PR and the determination whether or not the print range PR falls within the printable range PA in the first embodiment. However, since shape of the entire print range PRT becomes a non-rectangular shape due to the adjustment of the arrangement of the entire print range PRT, whether or not the entire print range PRT falls within the printable range PA may be determined by determining whether or not the coordinates of all the vertices when the entire print range PRT is considered to have rectangular shape falls within the printable range PA.

In a case where the adjusted entire print range PRT falls within the printable range PA (Yes in STEP S63), the control unit 110 moves the process to STEP S21. In this case, the printing based on the printing job of which the entire print range PRT (the partial print range PRP) is adjusted, is executed. On the other hand, in a case where the adjusted entire print range PRT does not fall within the printable range PA (No in STEP S63), the control unit 110 moves the process to STEP S29.

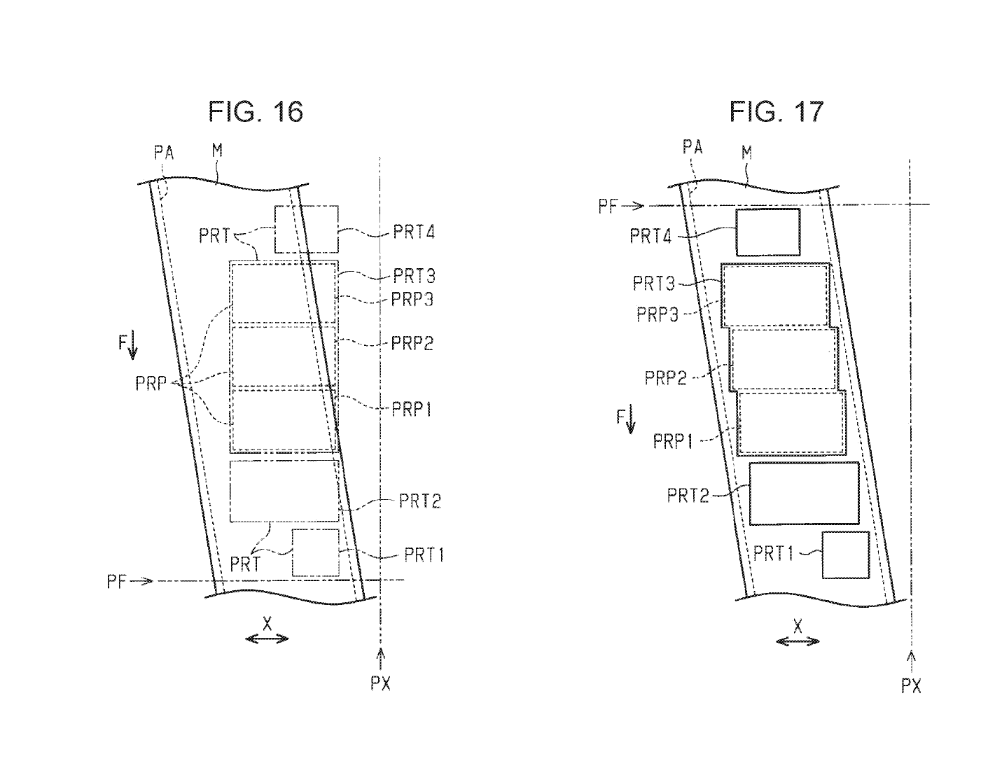

Next, actions of the printer 10 according to the third embodiment will be described with reference to FIG. 16 and FIG. 17. In FIG. 16 and FIG. 17, the arrangements of the entire print ranges PRT of a plurality of printing jobs with respect to the printable range PA of the skewed medium M, are illustrated. In FIG. 16 and FIG. 17, the entire print range PRT of the printing job for which the printing is finished are illustrated in solid lines, the entire print range PRT of the printing job of which the adjustment of the arrangement is not performed, that is, the printing job waiting for the execution of printing, is illustrated in two-dot chain lines, and the partial print ranges PRP included in the entire print range PRT are illustrated in chain lines.

Here, in the printer 10, in a case of starting the printing based on a plurality of printing jobs, the skewing tendency value ST is calculated. Subsequently, the printable range PA is calculated based on the skewing tendency value ST. Then, the executability of printing the printing job is determined in order of inputting the printing jobs to the printer 10. That is, the executability of printing is determined in order of the first printing job, the second printing job, the third printing job, and the fourth printing job.

As illustrated in FIG. 16, in the third embodiment, a case is assumed where the printing job having the print range PR similar to that in FIG. 8 is input. However, a different point in the third embodiment is that the third printing job is a printing job for printing three images.

As illustrated in FIG. 16 and FIG. 17, since an entire print range PRT1 of the first printing job falls within the printable range PA, the printing based on the first printing job is executed without the adjustment of the entire print range PRT1 being performed. Subsequently, since an entire print range PRT2 of the second printing job falls within the printable range PA by adjusting the arrangement, the printing based on the second printing job of which the entire print range PRT2 is adjusted is executed.

Then, an entire print range PRT3 based on the third printing job does not fall within the printable range PA even by adjusting the arrangement, the adjustment of the arrangement of the partial print ranges PRP1, PRP2, and PRP3 is performed. That is, as illustrated in FIG. 16 and FIG. 17, the arrangement of a plurality of partial print ranges PRP1, PRP2, and PRP3 arranged in the transport direction F is adjusted (moved) so as to move to the second end side in the width direction X along with the transport direction F. In this way, since the entire print range PRT3 of the third printing job falls within the printable range PA by the adjustment of the partial print range PRP, the printing based on the third printing job of which the entire print range PRT3 (the partial print range PRP) is adjusted is executed.

Then, since the entire print range PRT4 of the fourth printing job falls within the printable range PA by adjusting the arrangement, the printing based on the fourth printing job of which the entire print range PRT4 is adjusted is executed.

In this way, according to the third embodiment, even in a case where there is a printing job that does not fall within the printable range PA by adjusting the arrangement of the entire print range PRT, if the entire print range PRT of the printing job falls within the printable range PA by the adjustment of the arrangement of the partial print ranges PRP, the printing is executed.

According to the third embodiment, following effects can be achieved in addition to the effects 1 to 6 in the first embodiment.

8. When the entire print range PRT falls within the printable range PA by adjusting the arrangement of at least one partial print range PRP among a plurality of partial print ranges PRP in the width direction X, the execution of printing based on the printing job of which the partial print range PRP is adjusted is permitted. Therefore, the number of printing jobs Nj that can be continuously processed is increased compared to a case where the adjustment of the partial print range PRP is not performed, and thus, it is possible to improve the printing efficiency.

In the embodiment described above, a modification can be made as follows.

In the third embodiment, when performing printing based on the printing job for printing a plurality of images, in some cases it is not desired to adjust the arrangement of the partial print range PRP. For example, in a case where there is a printing job for printing two or more copies of two or more images. Even if the adjustment of the arrangement of the partial print range PRP can be permitted in the unit of copy, in some cases, the individual adjustment of the arrangement of an individual partial print range PRP cannot be permitted.

Therefore, in the third embodiment, the control unit 110 may select the partial print range PRP of which the arrangement in the width direction X is adjusted among the plurality of partial print ranges PRP based on the instruction input from the user. In this way, it is possible to select the partial print range PRP of which the arrangement is adjusted among the plurality of partial print ranges PRP. Therefore, it is possible to execute the printing of the image of which a print position on the medium M is not desired to be changed among a plurality of images included in the printing job, without changing the print position.

In the flowchart illustrated in FIG. 7, the skewing tendency value ST is calculated based on the skew amount S (the third skew amount S3 and the fourth skew amount S4) before and after the printing, and then, it is determined whether or not the transportation error occurs by comparing the skewing tendency value ST and the tendency determination value STth. However, this process may not be used.

For example, during the execution of printing in STEP S22, the skew amount S may be acquired when the transport operation is performed, and then, the skewing tendency value ST may be calculated based on an increased amount of the skew amount S before and after transport operation. Then, it may be determined whether or not the skewing tendency value ST calculated as described above is equal to or greater than the tendency determination value STth. According to this way, it is possible to detect the transportation failure occurring during the execution of printing based on one printing job.

In the flowchart illustrated in FIG. 7, the processing items in STEPs S21, S23, S24, and S25 may be omitted. That is, during the execution of printing based on the printing job, even if the skewing tendency value ST changes, the error notification may not be performed.

In the flowchart illustrated in FIG. 7, the processing items in STEPs S27 and S28 may be omitted. That is, upon executing the printing based on the printing job, the adjustment of the arrangement of the print range PR may not be performed.

In the flowchart illustrated in FIG. 7, the processing items in STEPs S29, S30, and S31 may be omitted. That is, in STEP S28, in a case where the print range PR does not fall within the printable range PA (No in STEP S28), the control unit may notify of the error.

In STEP S16 in the flowchart illustrated in FIG. 7, only stop processing that stops the execution of printing based on the printing job may be performed, or only notification processing that notifies that the medium M skews to the extent not suitable for printing may be performed.

In the embodiment described above, the skew amount S of the medium M increases while the transportation amount of the medium M increases. However, it can be considered that there may be a case where the skew amount S decreases to an amount smaller than “0 (zero)” with the increase of the transportation amount of the medium M. In this case, the initial skewing tendency value STi and the skewing tendency value ST become smaller than “0 (zero)”. Therefore, it is desirable to decrease the tendency determination value STth to an amount smaller than “0 (zero)”. Then in STEPs S15 and S25 in the flowchart illustrated in FIG. 7, it is desirable to determine whether or not the initial skewing tendency value STi and the skewing tendency value ST are equal to or smaller than the tendency determination value STth.

In STEPs S15 and S25 in the flowchart illustrated in FIG. 7, the determination may not be performed by comparing the amount of the initial skewing tendency value STi and the skewing tendency value ST, and the amount of the tendency determination value STth. For example, after the calculating the estimated skew amount corresponding to the transportation amount, it may be determined whether or not the absolute value of the difference between the estimated skew amount and the actual skew amount becomes equal to or greater than a predetermined determination value. That is, if it is possible to determine whether or not the value indicating the skewing tendency is equal to or greater than the predetermined determination value, the determination may be performed based on another value indicating the skewing tendency.

In STEP S49 in the flowchart illustrated in FIG. 13, only the printing job number Nx of which the printing is executed may be received. That is, in next STEP S50, the printing based on only the printing job having the printing job number Nx received in STEP S49, may be executed.

In the flowchart illustrated in FIG. 13, in a case where the print range PR does not fall within the printable range PA (No in STEP S44), the arrangement of the print range PR may adjusted as in STEP S27. Then, in a case where the print range PR after the adjustment falls within the printable range, the control unit 110 may move the process to STEP S45. On the other hand, in a case where the print range PR after the adjustment does not fall within the printable range, the process may be moved to STEP S48. According to this configuration, in the second embodiment, the effects (2) according to the first embodiment can be achieved.

The detection unit 52 may not be a reflection type photoelectric sensor. For example, the detection unit 52 may be an imaging unit (a camera) that images the medium M and the supporter 30. In this case, it is desirable for the control unit 110 to calculate the skew amount S of the medium M by performing image processing on the image imaged by the imaging unit.

The detection unit 52 may not be provided in the range overlapping the printing unit 50 in the transport direction. For example, the detection unit 52 may be provided on the upstream side of the printing unit 50 in the transport direction on the carriage 53, or may be provided on the downstream side in the transport direction. In addition, the detection unit 52 may not be provided on the carriage 53. In addition, a plurality of detection units 52 may be arranged in the transport direction F with intervals.

In a case where the printing is performed on the entire range of the medium M, that is, so-called borderless printing is performed, the entire range of the medium M may be the printable range PA.

The printer 10 may be changed to a so-called full-in type printer 10 that does not include the carriage 53 but includes an elongated fixed discharge unit 51 corresponding to the entire width of the medium M. In this case, the discharge unit 51 may be configured such that the print range PR covers the entire width of the medium M by arranging a plurality of head units in parallel, in which nozzles are formed, or may be configured such that the print range PR covers the entire width of the medium M by arranging a multiple number of nozzles on a single long head so as to cover the entire width of the medium M.

Liquid injected from the discharge unit 51 is not limited to an ink, but may be, for example, a liquid material or the like in which particles of a functional material is dispersed or mixed in the liquid. For example, the recording may be performed by injecting a liquid material that includes a material such as an electrode material or a coloring material (pixel material) used for manufacturing a liquid crystal display, an electroluminescence (EL) display, a surface light emitting display or the like, in the form of being dispersed or dissolved.

The medium M may not be an elongated medium. For example, the medium M may be a single cut-sheet.

The medium M may not be limited to a sheet, but may be a plastic film, a thin film, or the like, or may be a fabric used in a textile printing apparatus.

This application claims priority under 35 U.S.C. §119 to Japanese Patent Application No. 2015-133341, filed Jul. 2, 2015. The entire disclosure of Japanese Patent Application No. 2015-133341 is hereby incorporated herein by reference.

What is claimed is:

1. A print control apparatus of a printer including a transport unit that transports a medium in a transport direction, a detection unit that can detect a skew amount of the medium, and a printing unit that performs printing on the medium based on a printing job, the apparatus comprising:
a control unit that determines whether or not a print range of the printing job falls within a printable range of the medium calculated based on a result of detection by the detection unit in the transport direction and in a width direction crossing the transport direction, and that permits an execution of printing based on the printing job in a case where the print range falls within the printable range.

2. The print control apparatus according to claim 1,
wherein the control unit can adjust an arrangement of the print range with respect to the printable range, and
wherein, in a case where the print range does not fall within the printable range, when the print range falls within the printable range by adjusting the arrangement of the print range in the width direction, the control unit permits the execution of printing based on the printing job of which the print range is adjusted.

3. The print control apparatus according to claim 1,
wherein, in a case where there is a plurality of printing jobs, the control unit permits the execution of printing based on the printing job of which the print range falls within the printable range among the plurality of printing jobs, while limiting the execution of printing based on the printing job of which the print range does not fall within the printable range.

4. The print control apparatus according to claim 1,
wherein, in a case where there is a plurality of printing jobs, the control unit determines whether or not a plurality of print ranges of a plurality of printing jobs falls within the printable range, and in a case where the plurality of print ranges of the plurality of printing jobs does not fall within the printable range, the control unit selects a printing job to be permitted to execute printing from the printing jobs of which the print range falls within the printable range among the plurality of printing jobs based on an input instruction.

5. The print control apparatus according to claim 3,
wherein the control unit can change a printing order of the plurality of printing jobs.

6. The print control apparatus according to claim 1,
wherein the printing job is for printing a plurality of images in a row on the medium in the transport direction, and when the print range of the printing job is referred to as an entire print range, the entire print range includes partial print ranges which are print ranges of each of the plurality of images, and
wherein, in a case where the entire print range does not fall within the printable range, when the entire print range falls within the printable range by adjusting the arrangement of at least one partial print range among the plurality of partial print ranges in the width direction, the control unit permits the execution of printing based on the printing job of which the partial print range is adjusted.

7. The print control apparatus according to claim 6,
wherein the control unit selects a partial print range of which the arrangement in the width direction is adjusted among the plurality of partial print ranges based on an input instruction.

8. The print control apparatus according to claim 1,
wherein, in a case where a skewing tendency of the medium changes, when the printing is executed based on the printing job, the control unit executes at least one processing among notification processing that notifies of the change and stop processing that stops the printing.

9. A printer comprising:
the print control apparatus according to claim 1;
a transport unit that transports a medium in a transport direction;
a detection unit that can detect skewing of the medium; and
a printing unit that performs printing on the medium based on a printing job.

10. A printer comprising:
the print control apparatus according to claim 2;
a transport unit that transports a medium in a transport direction;
a detection unit that can detect skewing of the medium; and
a printing unit that performs printing on the medium based on a printing job.

11. A printer comprising:
the print control apparatus according to claim 3;
a transport unit that transports a medium in a transport direction;
a detection unit that can detect skewing of the medium; and
a printing unit that performs printing on the medium based on a printing job.

12. A printer comprising:
the print control apparatus according to claim 4;
a transport unit that transports a medium in a transport direction;
a detection unit that can detect skewing of the medium; and
a printing unit that performs printing on the medium based on a printing job.

13. A printer comprising:
the print control apparatus according to claim 5;
a transport unit that transports a medium in a transport direction;
a detection unit that can detect skewing of the medium; and
a printing unit that performs printing on the medium based on a printing job.

14. A printer comprising:
the print control apparatus according to claim 6;
a transport unit that transports a medium in a transport direction;
a detection unit that can detect skewing of the medium; and
a printing unit that performs printing on the medium based on a printing job.

15. A printer comprising:
the print control apparatus according to claim 7;
a transport unit that transports a medium in a transport direction;
a detection unit that can detect skewing of the medium; and
a printing unit that performs printing on the medium based on a printing job.

16. A printer comprising:
the print control apparatus according to claim 8;
a transport unit that transports a medium in a transport direction;
a detection unit that can detect skewing of the medium; and
a printing unit that performs printing on the medium based on a printing job.

17. The printer according to claim 9,
wherein the printing unit includes a discharge unit that discharges an ink toward the medium, and
wherein the detection unit is provided in a range overlapping the discharge unit in the transport direction.
